(19) United States
(12) Patent Application Publication
(10) Pub. No.: US 2005/0280821 A1
(43) Pub. Date: Dec. 22, 2005

(54) Illumination system having a light mixer for the homogenization of radiation distributions

(75) Inventors: Damian Fiolka, Oberkochen (DE); Wolfgang Singer, Aalen (DE); Johannes Wangler, Koenigsbronn (DE)

Correspondence Address: YOUNG & BASILE, P.C., 3001 WEST BIG BEAVER ROAD, SUITE 624, TROY, MI, 48084, US

(73) Assignee: Carl Zeiss SMT AG, Oberkochen (DE)

(21) Appl. No.: 11/147,931

(22) Filed: Jun. 8, 2005

Related U.S. Application Data
(60) Provisional application No. 60/578,521, filed on Jun. 10, 2004.

(51) Int. Cl. G01B 11/00

(52) U.S. Cl. 356/399

(57) ABSTRACT

An illumination system of a microlithographic projection exposure apparatus contains a light mixer for the homogenization of radiation distributions. The latter may, in one embodiment, comprise at least one plane beam-splitter layer which is arranged between two transparent sub-elements, parallel to an optical axis of the illumination system. An alternative embodiment of a light mixer contains at least one row of beam splitters, wherein the beam splitters in at least one row are arranged mutually parallel, at an inclination angle with respect to an entry-side optical axis of the illumination system, and offset behind one another in a direction perpendicular to the entry-side optical axis.

### CROSS-REFERENCE TO RELATED APPLICATIONS

This application claims priority of provisional U.S. patent application Ser. No. 60/578,521 filed Jun. 10, 2004. The full disclosure of this earlier application is incorporated herein by reference.

### BACKGROUND OF THE INVENTION

1. Field of the Invention

The invention relates to an illumination system of a microlithographic projection exposure apparatus, having a light mixer for the homogenization of radiation distributions.

2. Description of the Related Art

For the production of microstructured components, a plurality of structured layers are applied on a suitable substrate which, for example, may be a silicon wafer. In order to structure the layers, they are first covered with a photoresist which is sensitive to light of a particular wavelength range, for example light in the deep ultraviolet (DUV) spectral range. The wafer coated in this way is subsequently exposed in a projection exposure apparatus. A pattern of structures, which is arranged on a mask, is thereby imaged onto the photoresist with the aid of a projection objective.

After the photoresist has been developed, the wafer is subjected to an etching or deposition process so that the top layer becomes structured according to the pattern on the mask. The remaining photoresist is then removed from the other parts of the layer. This process is repeated until all the layers have been applied on the wafer.

The performance of the projection exposure apparatus being used is determined not only by the imaging properties of the projection objective but also by the properties of an illumination system which precedes the projection objective. Its purpose is to produce a projection light beam and direct it at the mask to be projected. To this end, the illumination system contains a light source, for example a laser operated in pulsed mode, and a plurality of optical elements which produce a projection light beam with the intended properties from the light delivered by the light source.

These properties include, inter alia, the homogeneity of the projection light beam directed at the mask. Specifically, each point on the mask should generally be illuminated with the same intensity and the same illumination angle distribution. Fluctuations in these quantities generally lead to undesirable structure width fluctuations of the components to be produced.

Light mixers, which homogenize an incident radiation distribution, are therefore often provided in illumination systems. The task of providing a homogeneous projection light beam is not trivial since the lasers conventionally used as a light source produce a Gaussian intensity profile, which needs to be converted by the subsequent optical elements into an intensity profile that is as rectangular as possible. Material and fabrication errors of these optical elements may in this case produce inhomogeneities of the intensity distribution. These optical elements may, for example, be raster elements such as microlens arrays, which are used to increase the geometrical optical flux, to set the illumination angle distribution and to establish the geometry of the light field which can be illuminated on the mask.

Often, another requirement of illumination systems is that they should provide projection light in an intended polarization state. This is because it has been found that in certain cases, for example when projecting structures which have a particular privileged direction, the use of linearly polarized light leads to a higher contrast in the imaging of the structures. Besides this, there are cases in which the reticle is intended to be illuminated not with linearly polarized light but with differently, for example circularly, polarized light or even with light not having any privileged polarization direction. For the illumination system, this means that the optical components contained in it should perturb a polarization state as little as possible once it has been set.

U.S. Pat. No. 6,285,443 A discloses an illumination system for a microlithographic projection exposure apparatus, in which a glass rod is used for mixing the light. In this case, the light is mixed by multiple total reflection of the transmitted light rays at the lateral surfaces of the glass rod. Such glass rods do not, however, preserve the polarization state of the light passing through.

EP 1 079 277 A1 discloses an illumination system which uses a light mixer referred to therein as a multiplexer. This known light mixer also has the task of reducing the temporal and spatial coherence level of the projection light. To this end, phase differences which exceed the coherence length of the projection light are introduced between light rays by multiple beam splitting. The beam splitters used in this case furthermore constitute additional virtual, spatially separated light sources so that the spatial coherence of the projection light is also destroyed.

To this end, the known light mixer has an arrangement of mutually adjacent beam-splitter elements which lies in a plane, each of them comprising a thin layer applied on a support and having different reflectivities. A plane mirror, which directs the light reflected by a beam-splitter element onto the respective neighbouring beam-splitter layer, is arranged parallel to this plane.

A disadvantage with this known light mixer is that the light intensities to which the individual beam-splitter layers are exposed vary significantly between the beam-splitter layers. The beam-splitter layer which is exposed to the incident light beam consequently degrades so quickly because of ageing phenomena that replacement is necessary within relatively short lengths of time. This known light mixer furthermore increases the cross-sectional area of the light significantly, which is often undesirable.

### SUMMARY OF THE INVENTION

It is an object of the invention to provide an illumination system for a microlithographic projection exposure apparatus, having a light mixer which at most slightly changes the polarization state of projection light passing through, and which does not necessarily increase the cross-sectional area of the light of the projection light beam as it passes through the light mixer.

According to a first aspect of the invention, this object is achieved by an illumination system having a light mixer, which comprises at least one plane beam-splitter layer arranged between two transparent sub-elements, parallel to an optical axis of the illumination system.

Such a beam-splitter layer arranged parallel to an optical axis of the illumination system makes it possible to symmetrize the incident light beam, since one part of the light can pass through the beam-splitter layer whereas the other part is reflected by it. Especially when two light beams converge symmetrically at the light mixer, on a plane defined by the beam-splitter layer, very good mixing of the two light beams can be achieved in this way. The closer the transmissivity of the at least one beam-splitter layer is to its reflectivity, and the nearer the beam-splitter layer is to the optical axis, the more complete the symmetrization will be.

Here, moreover, the term beam-splitter layer is intended to mean any layer which has the property of reflecting one part of the incident light and transmitting the other part as fully as possible. The absorption factor of the beam-splitter layers should therefore be as small as possible, preferably less than 5%, more preferably less than 1%.

In general, such beam-splitter layers comprise at least two individual layers with different refractive indices. The at least one beam-splitter layer may optionally be polarization-selective, if the light mixer is intended not merely to preserve the polarization state of light passing through but to modify it in a controlled way. Here, the term polarization-selective refers to those beam-splitter layers in which, unlike normal beam-splitter layers which have only a very small polarization selectivity, the reflectivity for s-polarized light differs from the reflectivity for p-polarized light by more than a factor of 2, preferably by more than a factor of 10.

In order to obtain symmetrization not merely with respect to one plane but with respect to a plurality of planes, the light mixer may also contain two or more beam-splitter layers which form an angle between each other. In the case of two beam-splitter layers, this angle should preferably be 90°.

In the most general case, the light mixer contains n beam-splitter layers, n=3, 4, 5, . . . , with two neighboring bean-splitter layers forming an angle of 360′/n between them.

The purpose of the sub-elements is essentially just to act as a support for the at least one beam-splitter layer. Owing to their refracting effect, however, they also influence the direction of the light rays passing through the light mixer.

The sub-elements may therefore be formed so that the light mixer is provided overall with a non-zero refracting power and therefore has an imaging effect. In general, however, it is more desirable for the light mixer to be non-refracting overall. In this context, the sub-elements should be formed so that the light mixer acts as a plane-parallel and therefore non-refracting plate for all the light rays passing through.

In general, therefore, the sub-elements will often be prisms which are constructed so that the light mixer has at least essentially the shape of a rhombus, a cuboid and in particular the shape of a cube, with the optical axis of the illumination system passing through an edge or a vertex of the cuboid. Such a shape of the light mixer is preferable, in particular, when a plurality of individual light beams strike the light mixer from different directions. In illumination systems of microlithographic projection exposure apparatus, for example, this is the case close to pupil planes which are only intended to be illuminated partially, for example inside a plurality of mutually separated poles.

For annular illumination of the pupil plane, as is the case in a so-called annular illumination setting, it is nevertheless more favorable for the light mixer to have a basic shape which can be described by two right circular cones touching each other at their base surfaces, which preferably have the same apex angle. Such a light mixer will be non-refracting for light which strikes it with an annular light cross section. The sub-elements from which the light mixer is constructed then have the shape of frustoconical segments.

If such a light mixer is arranged in an illumination system of a microlithographic projection exposure apparatus, then a field plane of the illumination system is particularly appropriate as its location. The field plane should then if possible pass through a symmetry plane of the light mixer.

According to a second aspect of the invention, the aforementioned object is achieved by an illumination system having a light mixer for the homogenization of radiation distributions, which comprises at least one row of beam splitters, wherein the beam splitters in at least one row
a. extend mutually parallel,
b. are arranged at an inclination angle with respect to an entry-side optical axis of the light mixer, and
c. are arranged offset behind one another in a direction perpendicular to the entry-side optical axis.

The inventive arrangement of a plurality of beam splitters, which may for example comprise a transparent support with a beam-splitter layer applied on top, can ensure that each individual light ray passes through at least two beam splitters. In this way, each incident light ray is split more than twice so that, with suitably selected dimensions, both the temporal and spatial coherence levels can be reduced considerably. Furthermore, all the beam splitters of the first row on the entry side can be exposed to light simultaneously, so that the geometry of the entry-side light distribution can be preserved by the light mixer. The light mixer is therefore particularly suitable for applications in which an increase of the light aperture is undesirable.

Furthermore, the beam-splitter layers in the light mixer according to the invention are irradiated relatively uniformly, so that degradation phenomena due to high radiation intensities occur less rapidly.

If the light mixer causes no offset of the light beam, then the entry-side optical axis coincides with the exit-side optical axis of the illumination system.

The situation is simplest when the inclination angle of the at least one row is 45°. A light ray striking the beam splitter parallel to the entry-side optical axis will then be split into a subsidiary ray continuing forward and a subsidiary ray deviated through 90° by reflection. This is compatible with a grid-like arrangement of the individual beam splitters inside the light mixer.

The light mixer according to this second aspect can furthermore be used as part of a honeycomb condenser, which has the property of substantially destroying the temporal and spatial coherence of the light.

In order to achieve optimal homogenization, the inclination angles respectively differ from one another in magnitude by 90° in rows which follow one another along the entry-side optical axis. A homogeneous intensity distribution is thereby achieved in the exit beam.

If the light mixer contains at least two successively arranged rows of beam splitters, then this ensures that virtually any light ray entering the light mixer strikes at least two beam splitters as it passes through the light mixer. The situation is sometimes different for light rays which strike particular beam splitters at the outer edges of the rows. So that such light rays do not escape laterally from the light mixer, an additional deviating device may be provided by which light reflected from an outermost beam splitter of a row is directed onto a subsequent row. Such a deviating device may, for example, contain one or more plane mirrors which direct the light onto a beam splitter of a subsequent row.

If the light mixer is irradiated with collimated light, then the beam splitters may be arranged so densely that the light mixer is exposed to a light cross section of large area on the entry side. The light mixer according to the second aspect of the invention, moreover, also makes it possible to homogenize ulicollimated light and therefore reduce its coherence level. To this end, it is merely necessary for an optical element with a positive refracting power to be arranged between at least two beam splitters. The optical elements, which may for example be lenses or diffractive optical elements, transport the light aperture through the arrangement of the beam splitters.

Preferably, therefore, an optical element with a positive refracting power is respectively arranged between two beam splitters next to each other along the entry-side optical axis or perpendicularly to it. Then, however, the light mixer can no longer be irradiated with a light cross section of large area without loss by absorption or reflection of the light striking the intermediate spaces between the entry-side optical elements. In order to prevent this, the light mixer may contain an imaging unit on the entry side, which splits an integral incident light beam into subsidiary light beams that are directed at the entry-side beam splitters. To this end, for example, the imaging unit may contain a lens array which contains as many lenses as there are beam splitters to be illuminated. The imaging unit may also contain a plurality of planes of lenses arranged behind one another. In order to obtain an integral light beam again on the exit side, appropriate imaging unit may likewise be provided there.

### BRIEF DESCRIPTION OF THE DRAWINGS

Various features and advantages of the present invention may be more readily understood with reference to the following detailed description taken in conjunction with the accompanying drawing in which:

FIG. 1 shows a schematic representation, not true to scale, of an illumination system of a microlithographic projection exposure apparatus in a meridian section;

FIG. 2 shows a perspective representation of a light mixer contained in the illumination device shown in FIG. 1, according to a first exemplary embodiment;

FIG. 3 shows a section through the light mixer shown in FIG. 2, along the line III-III;

FIG. 4 shows a perspective representation of a light mixer suitable for the illumination system of FIG. 1, according to a second exemplary embodiment;

FIG. 5 shows a section through the light mixer shown in FIG. 4;

FIG. 6 shows a section through the light mixer shown in FIGS. 4 and 5, along the line VI-VI;

FIG. 7 shows a meridian section through a light mixer according to a third exemplary embodiment, having a plurality of rows of beam splitters;

FIG. 8 shows an enlarged representation of a mixing unit contained in the light mixer of FIG. 7;

FIG. 9 shows a simplified meridian section through a light mixer according to a fourth exemplary embodiment, having a plurality of rows of beam-splitter cubes.

### DESCRIPTION OF PREFERRED EMBODIMENTS

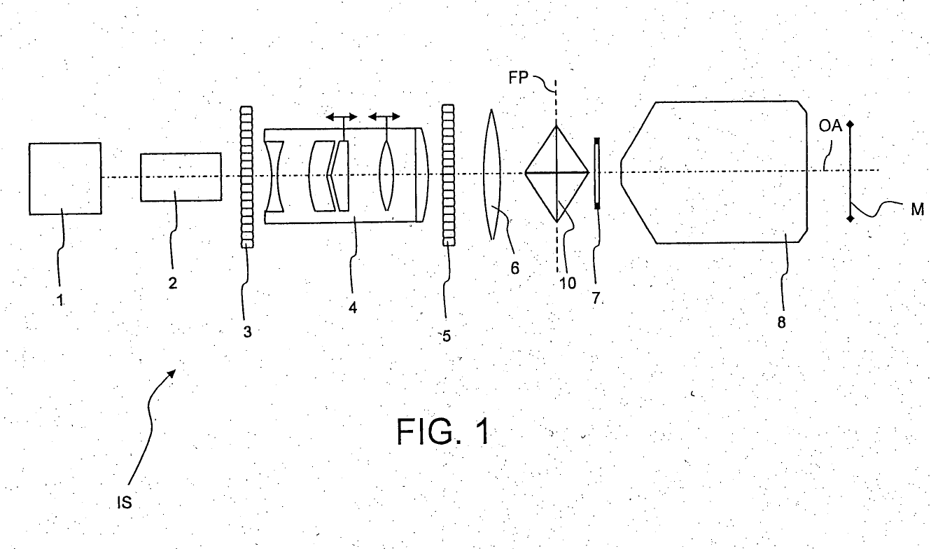

FIG. 1 shows an illumination system, denoted in its entirety by IS, of a microlithographic projection exposure apparatus in a highly simplified meridian section which is not true to scale. The illumination system IS comprises a laser 1 used as a light source, which produces a collimated light beam, a beam shaping device 2, a first optical raster element 3 which is the first element that increases the divergence of the light beam, a zoom-axicon objective 4 for setting different types of illumination, and a second optical raster element 5. Arranged in the beam path behind these, there are a condenser lens 6, a light mixer 10 through which a field plane FP passes, and an adjustable masking device 7 which can set the geometry of the light field passing through the reticle.

The illumination system IS furthermore comprises a masking objective 8, the masking device 7 being arranged in its object plane and a mask M being arranged in its image plane. The masking device 7 is thus imaged sharply onto the mask M by the masking objective 8, and therefore ensures sharp edges of the light field.

Since the illumination system IS is known to this extent, for further details reference will be made to the Applicant's U.S. Pat. No. 6,285,443 and to the documents cited therein. It is of course also possible to use illumination systems different from this, for example those in which the illumination angle distribution is set in another way.

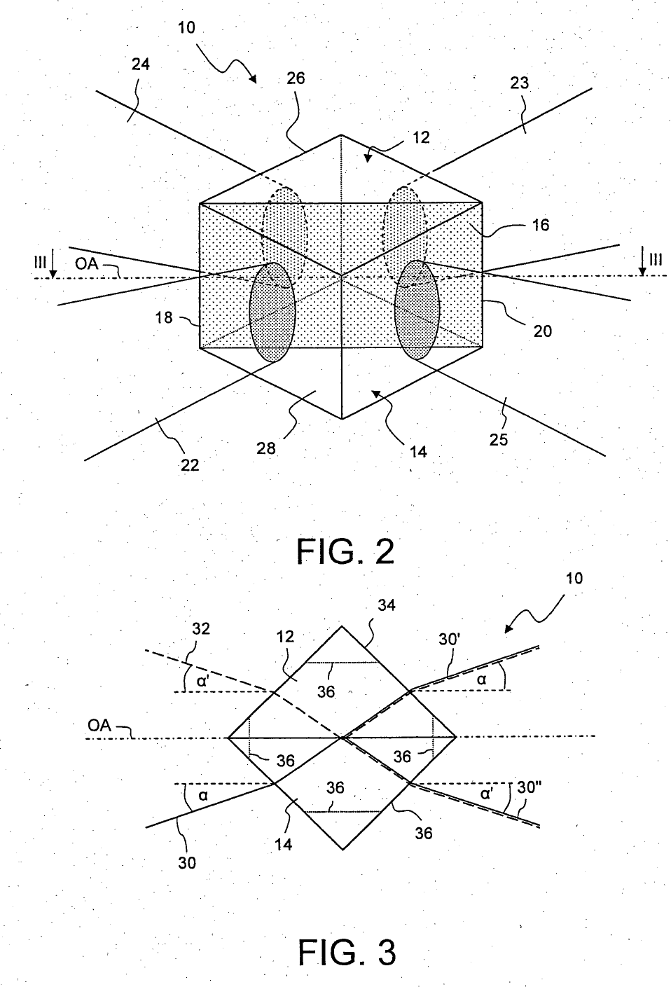

FIG. 2 represents the light mixer 10 in perspective. The light mixer comprises a first wedge prism 12 and a second wedge prism 14, the base surfaces of which respectively have the shape of a right-angled isosceles triangle. The two wedge prisms 12, 14 are joined to each other via a beam-splitter layer 16 on their hypotenuse surfaces. The light mixer 10 therefore has the overall shape of a cuboid with a square base surface.

The two wedge prisms 12, 14 respectively consist of a material which is transparent for the light being used. The beam-splitter layer 16 comprises a plurality of thin individual dielectric layers, the refractive indices of which are matched to one another in a manner known per se so that the beam-splitter layer 16 transmits and reflects incident light in approximately equal parts. The absorptivity of the beam-splitter layer 16 should be as low as possible for the light being used, so that T=R≈50% applies for the transmissivity T and the reflectivity R.

In the arrangement shown in FIG. 2, the light mixer 10 is oriented so that an optical axis OA of the illumination system passes through the beam-splitter layer 16. The optical axis OA therefore extends through the edges 18, 20 of the light mixer 10.

If two incident light beams 22, 24 now strike the leg surfaces 26, 28 of the light mixer symmetrically with respect to the beam-splitter layer 16 then, owing to its cuboid shape, the light mixer 10 acts overall as a non-refracting plane-parallel plate for the light distribution consisting of the light beams 22, 24. Although the light mixer 10 consequently generates certain imaging errors such as spherical aberration and coma, it is nevertheless comparatively easy to compensate for these imaging errors by measures known per se when configuring the illumination system IS. On rear leg surfaces, which lie opposite the entry-side leg surfaces 26, 28, two light beams 23, 25 therefore emerge from the light mixer 10 at angles of equal magnitude with respect to the optical axis OA.

The way in which the beam-splitter layer 16 arranged between the wedge prisms 12, 14 symmetrizes the light distribution arriving on the light mixer 10 will be explained below with reference to FIG. 3. FIG. 3 shows a sectional representation of the light mixer 10 along the line III-III. The section plane therefore extends perpendicularly to the beam-splitter layer 16 and contains the optical axis OA.

The sectional representation shows two light rays 30, 32 of the incident light beams 22 and 24, respectively by lines represented as solid and dashed. For the sake of clarity, it is assumed here that the two light rays 30, 32 also arrive on the light mixer 10 symmetrically with respect to the beam-splitter layer 16, and specifically at angles α and α′ with respect to the optical axis OA which are equal in magnitude but oppositely oriented. It can be seen in FIG. 3 that the two light rays 30, 32 are refracted when they are arrive at the wedge prisms 12 and 14, respectively, and then converge onto the beam-splitter layer 16 arranged between the wedge prisms 12, 14. The light ray 30 indicated by a solid line passes through the beam-splitter layer 16 with about 50% of its intensity and, after refraction at a rear leg side 34 of the first wedge prism 12, emerges at the angle α from the light mixer 10 as a subsidiary beam 30′. For the transmitted subsidiary ray, as mentioned above, the light mixer 10 acts as a plane-parallel plate.

With about 50% of its intensity, the light ray 30 is reflected at the beam-splitter layer 16 and is deflected onto a rear leg surface 36 of the first wedge prism 12 as a subsidiary ray 30″. After refraction at this interface, the reflected subsidiary ray 30″ leaves the light mixer 10 at the angle α′.

Since the situation is exactly the reverse for the second incident light ray 32, the light mixer 10 causes overall symmetrization of the radiation distribution. This can be confirmed by assuming, for example, that the second incident light ray 32 has a lower intensity than the first incident light ray 30. Since the subsidiary rays due to the splitting at the beam-splitter layer 16 each have the same intensity, a reflected subsidiary light ray and a transmitted subsidiary light ray are respectively superimposed to form an emerging light ray, the intensity of which is equal to half the sum of the intensities which the two incident light rays 30, 32 respectively have. For a beam-splitter layer 16 whose reflectivity is exactly equal to the transmissivity, the symmetrization of the intensities of the incident light rays 30, 32 is therefore complete, irrespective of the size of the difference of these intensities.

As can be shown by a simple calculation, the symmetrization is commensurately weaker the more the reflectivity of the beam-splitter layer 16 differs from its transmissivity. It is nevertheless found that with small differences between the intensities of the incident light rays 30, 32, good symmetrization is achieved even if the reflectivity of the beam-splitter layer 16 is only approximately the same as its transmissivity.

If symmetrization is intended only for a particular polarization state, then the beam-splitter layer 16 may also be designed to be polarization-selective. Such polarization-selective beam-splitter layers are likewise known in the prior art, so that no further explanations are necessary in this regard.

As can be seen very clearly from the sectional representation in FIG. 3, light does not pass through the entire volume of the light mixer 10. Those regions through which light does not pass may therefore be omitted in order to save material. In FIG. 3, partition lines 36 represented by dots indicate the regions of the wedge prisms 12, 14 which can be removed without compromising the effect of the light mixer. The light mixer 10 would then have the shape of an octahedron instead of the shape of a cuboid.

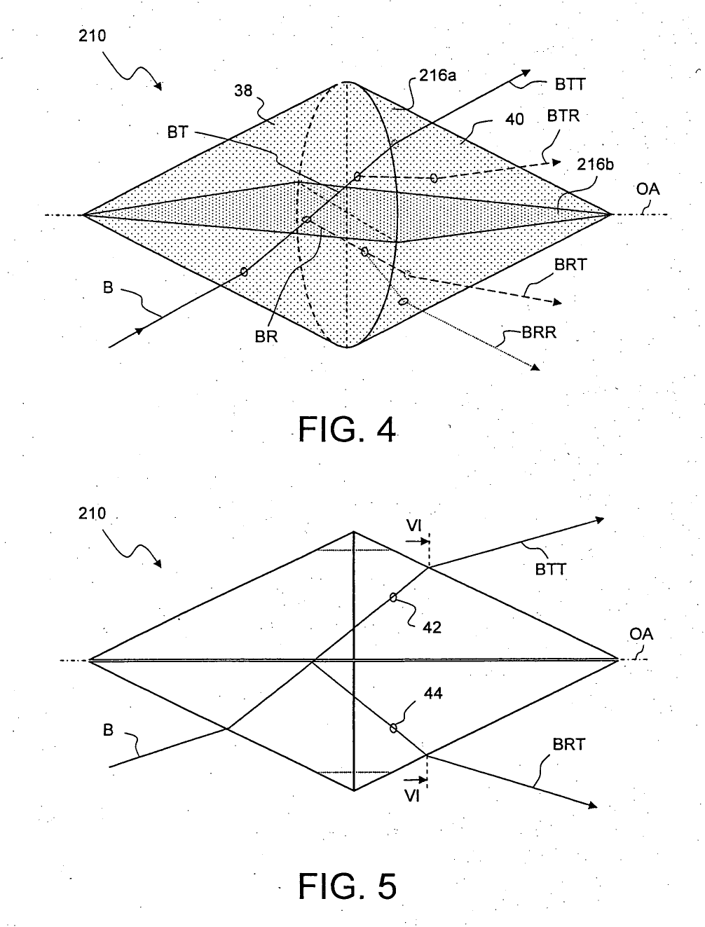

FIGS. 4 to 6 show a light mixer 210 according to a second exemplary embodiment of the invention, respectively in a perspective representation, a sectional representation corresponding to FIG. 2 and a section along the line VI-VI. Parts which are the same or correspond to one another are in this case denoted by reference numerals increased by 200.

The light mixer 210 differs from the light mixer 10 represented in FIGS. 2 and 3, inter alia, in that it contains not just one beam-splitter layer but two, which are highlighted in FIG. 4 by different densities of dots. The two beam-splitter layers 216a, 216b are likewise plane here, and have the property that the reflectivity is approximately the same as the transmissivity. The two beam-splitter layers 216a, 216b are arranged mutually perpendicular, with the optical axis OA passing through the section line of the beam-splitter layers 216a, 216b.

The basic shape of the light mixer 210 can be described by two right circular cones 38, 40 whose base surfaces touch each other. Each of the two circular cones 38, 40 is subdivided into four cone segments, not described in detail, between which the two beam-splitter layers 216a, 216b extend.

The path of an incident light ray B through the light mixer 210 will be described below. The light ray B arriving on the light mixer at an angle with respect to the optical axis OA is first refracted at a lateral surface of the cone 38 and, in the arrangement represented here by way of example, firstly strikes the second beam-splitter layer 216b. The light ray B arriving on the second beam-splitter layer 216b is split at the second beam-splitter layer 216b into a subsidiary ray BT continuing forward and a reflected subsidiary ray BR. The two subsidiary rays BT, BR then respectively strike the first beam-splitter layer 216a, where they are each split again into two subsidiary rays BTT, BTR and BRT, BRR. A total of four subsidiary rays are therefore obtained from the incident light ray B, namely a subsidiary ray BTT which has not been reflected at all (solid line), two subsidiary rays BTR and BRT, each of which has been reflected once when passing through the light mixer 210 (dashed), and a fourth light ray BRR which has been reflected twice when passing through the light mixer 210 (dotted line).

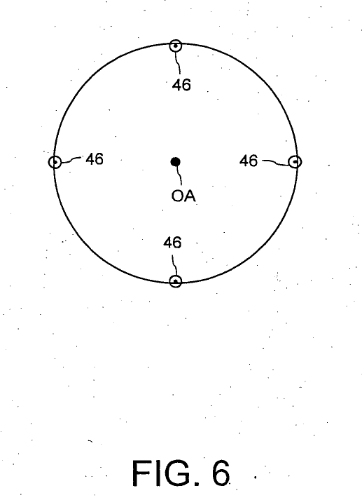

FIG. 5 shows a section through the light mixer 210, the section plane being defined by the direction of the incident light ray B and the normal to the second beam-splitter surface 216b. It can be seen in FIG. 5 that the subsidiary ray BTT which passes through the two beam-splitter layers 216a, 216b and the subsidiary ray BRT which is reflected only at the second beam-splitter layer 216b form a similar configuration as the rays 30, 30′ and 30″ which are shown in FIG. 3. Unlike the rays 30′ and 30″ in the case of the light mixer 10, however, the subsidiary rays BTT and BRT have only one quarter of the intensity of the incident ray B. The other half of the intensity is distributed between the subsidiary rays BTR and BRR (not visible in FIG. 5) which have been reflected at the positions indicated by small ellipses 42 and 44 on the first beam-splitter layer 216a, and deflected out of the plane of the paper.

The subsidiary rays BRT and BRR not visible in FIG. 5 emerge from the light mixer 210 at angles of equal magnitude with respect to the optical axis OA, and specifically in a plane which can be described by tilting the plane of the paper about a vertical axis. The points where the subsidiary rays BTT, BTR, BRT and BRR cross a plane of the light mixer 210 perpendicular to the optical axis OA are indicated by small circles 46 in FIG. 6, which shows a section through the light mixer 210 along the line VI-VI. The optical axis OA, which passes through the apices of the cones 38, 40, extends symmetrically with respect to this arrangement of points.

As shown in particular by FIGS. 5 and 6, the light mixer 210 has a similar symmetrizing effect as the light mixer 10, but with the difference that the effect is rotationally symmetric overall. Owing to this rotational symmetry, the light mixer 210 is particularly suitable for symmetrizing rotationally symmetric light distributions. Particular examples of this are annular light distributions in which the light beam has the shape of a lateral cone surface. Such annular light distributions are encountered, for example, close to a pupil plane of the illumination system IS in a so-called annular illumination setting.

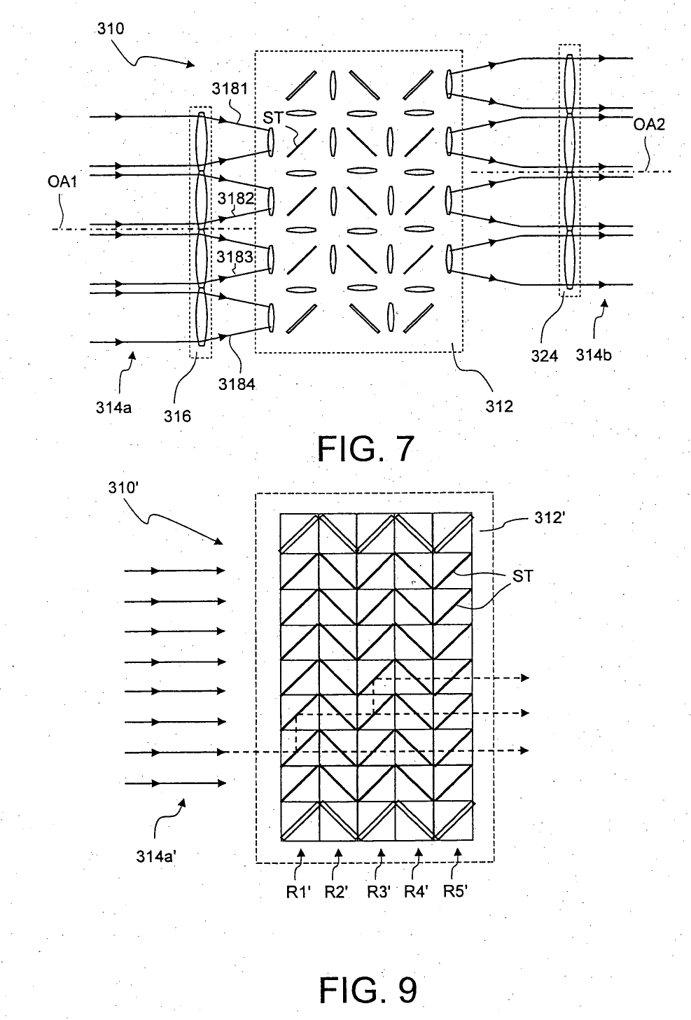

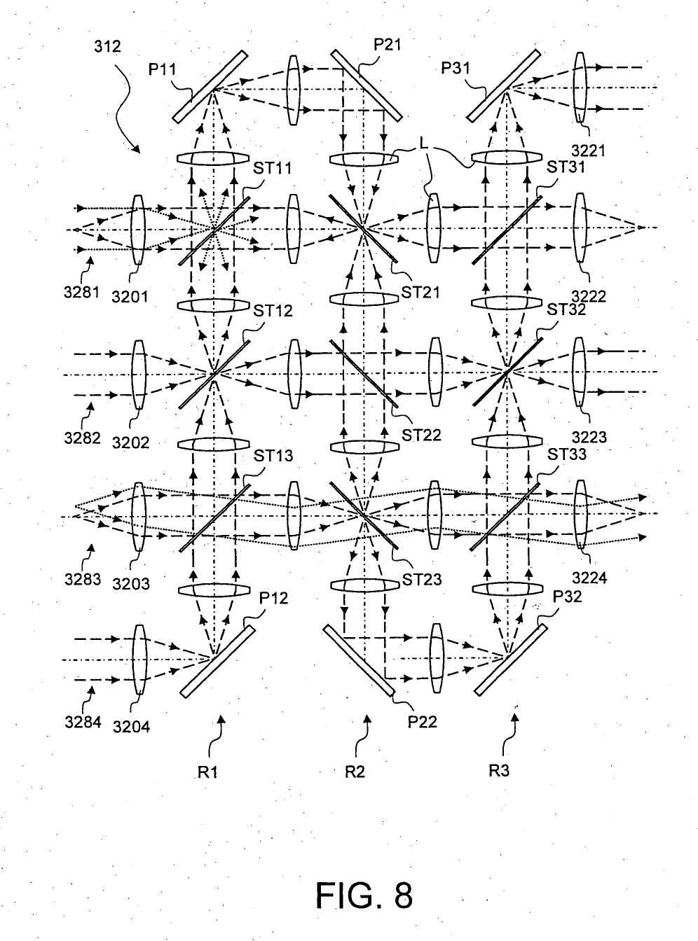

FIG. 7 shows a light mixer, denoted overall by 310, according to another aspect of the invention. An incident light beam 314a, which strikes the light mixer 310 symmetrically with respect to an entry-side optical axis OA1 and need not be collimated, first passes through a lens grid 316 consisting of a plurality of individual lenses adjacent to one another without gaps. The lens grid 316 subdivides the incident light beam 314a into a plurality of mutually separated subsidiary beams 3181, 3182, 3183 and 3184, which strike a mixing unit 312 shown on an enlarged scale with additional details in FIG. 8.

There, as can be seen in FIG. 8, the mutually separated subsidiary beams 3181 to 3184 respectively strike the entry lenses 3201, 3202, 3203 and 3204, which direct the subsidiary beams 3181 to 3184 onto a first row R1 of beam splitters ST11, ST12, ST13 and a plane mirror P12. The beam splitters ST11, ST12, ST13 respectively contain a beam-splitter layer, which is applied on a thin plane-parallel support plate, transmits about 50% of the incident light and reflects the remaining 50%.

The three beam splitters ST11, ST12, ST13 and the plane mirror P12 are arranged mutually parallel, respectively at an angle of 45° with respect to the entry-side optical axis OA1. Behind the first row R1 of beam splitters, there is a second row R2 of beam splitters ST21, ST22, ST23, which are tilted by 90° relative to the beam splitters of the first row R1. This is followed by a third row R3 of beam splitters ST31, ST32, ST33, which are again oriented with respect to the entry-side optical axis OA1 in the same way as the beam splitters of the first row R1.

By dashed and dotted lines which indicate the individual rays of the subsidiary beams 3181 to 3184, FIG. 8 shows the way in which the light entering the mixing unit 312 through the entry lenses 3201 to 3204 is subdivided by multiple splitting at the beam splitters ST into subsidiary beams of weaker and weaker intensity, and finally leaves the mixing unit 312 again via exit lenses 3221 to 3224. A second lens grid 324 on the exit side (see FIG. 7) recombines the subsidiary beams leaving the mixing unit 312 to form a common and now homogenized light beam 314b. The light mixer 310 does not change the cross section of the incident light beam 314a, but merely offsets the light beam 314a parallel to the entry-side optical axis OA1. An exit-side optical axis OA2 therefore extends parallel to, but not collinear with the entry-side optical axis OA1.

Since the subsidiary rays created by the multiple splitting travel paths of different length inside the mixing unit 312, the emerging light beam 314b has a significantly reduced temporal coherence level. Besides this, the spatial coherence level is also reduced since a light ray, for example entering the mixing unit 312 through the entry lens 3201, is split up so that the subsidiary rays emerge from the mixing unit 312 over all the exit lenses 3221 to 3224. The exit lenses 3221 to 3224 therefore have the effect of virtual light sources, which reduce the spatial coherence level of the light.

The larger the number of beam splitters ST is, the better the homogenizing effect of the light mixer 312 will be. For the reduction in the spatial coherence level, however, it is not the number of beam splittings which is important but the optical path-length differences which exist between two subsidiary rays that originate from one incident ray. These path-length differences should be selected so that they exceed the coherence length of the incident light. For a wavelength of 157 nm, the coherence length is for example about 10 mm.

So that no light is lost at the outer edges in the direction perpendicular to the entry-side optical axis OA1, two plane-parallel plates P12 and P22, P21 and P22, and P31 and P32 are respectively provided in each of the rows R1 to R3 of the mixing unit 312 shown in FIG. 8. The plane mirrors are in this case oriented just like the beam splitters ST in the relevant row so that neighbouring plane mirrors, for example the plane mirrors P11 and P12, reverse the rays into a subsequent row.

In the exemplary embodiment represented, it is assumed that the light beam 314a arriving on the light mixer 310 is not collimated but has a non-zero divergence. In addition to the entry lenses 3201 to 3204 and the exit lenses 3221 to 3224, it is therefore necessary to arrange further lenses (denoted by L) inside the mixing unit 312, so that the light aperture can be transported through the mixing unit 312. In the exemplary embodiment represented, therefore, between two neighboring beam splitters ST or plane mirrors P there is respectively a converging lens L whose focal length f corresponds to the distance between each beam-splitter or plane-mirror centre and the lens L.

If the light beam 314a arriving on the light mixer 310 is collimated, then there is no need to arrange converging lenses L between the beam splitters ST. In this case, the beam splitters ST may be fitted immediately next to one another so as to provide the arrangement of a mixing unit 312′ as shown in FIG. 9. Since the beam splitters of the first row R1′ offer a continuous surface for arrival of the collimated light beam 314a′, with this arrangement of the beam splitters ST it is also unnecessary to have any entry-side and exit-side lens grids 316 or 324. The arrangement of the beam splitters ST as shown in FIG. 9 furthermore allows them to be designed as small beam-splitter cubes which adjoin to one another without gaps. This highly compact structure allows a large number of rows R1′ to R5′ of beam splitters ST to be arranged in a very small space.

It should be understood that for light beams 314a whose maximum extents in two mutually perpendicular directions are approximately equal, the light mixer 310 or 310′ may be supplemented with additional planes of beam splitters which are arranged stacked behind one another in the direction perpendicular to the plane of the paper. If homogenization is also intended to be achieved in the direction perpendicular to the plane of the paper then, for example, this may be done by delivering the light beam 314b emerging from the light mixer 310 or 310′ into a second light mixer, which is designed just like the light mixer 310 or 310′ but is rotated through 90° about the optical axis.

The light mixers 310 or 310′ shown in FIGS. 7 to 9 may also be used in the illumination system IS. Since the light mixer 310 shown in FIGS. 7 and 8 does not require the use of collimated light, it is also possible to arrange the light mixer 310 behind those optical elements of the illumination system which were the first to introduce a beam divergence. For example, the field plane FP shown in FIG. 1 is therefore also suitable.

The light mixer 310′, however, can only be used in a parallel beam path. A suitable position is a location before the first optical raster element 3, which increases the divergence of the projection light beam for the first time, and preferably even before the beam shaping unit 2, i.e. immediately behind the laser 1. The light mixer 310′ then homogenizes the projection light produced by the laser 1 before it strikes subsequent optical elements.

1. An illumination system of a microlithographic projection exposure apparatus, comprising:
an optical axis and
a light mixer for the homogenization of radiation distributions, said light mixer comprising at least one plane beam-splitter layer which
is arranged between two transparent sub-elements and
extends parallel to the optical axis.

2. The illumination system of claim 1, wherein the at least one beam-splitter layer has a transmissivity that is at least approximately equal to its reflectivity.

3. The illumination system of claim 1, wherein the at least one beam-splitter layer contains the optical axis.

4. The illumination system of claim 1, comprising two beam-splitter layers that form an angle between each other.

5. The illumination system of claim 4, wherein the angle is 90°.

6. The illumination system of claim 4, wherein the light mixer comprises m beam-splitter layers, m=3, 4, . . . , with two neighboring beam-splitter layers forming an angle of 360°/m between them.

7. The illumination system of claim 1, wherein the sub-elements all have the same basic geometrical shape.

8. The illumination system of claim 7, wherein the sub-elements are prisms.

9. The illumination system of claim 8, wherein the light mixer at least substantially has the shape of a cuboid, with the optical axis passing through an edge of the cuboid.

10. The illumination system of claim 9, wherein the optical axis passes through a vertex of the cuboid.

11. The illumination system of claim 8, wherein the light mixer at least essentially has the shape of a cube.

12. The illumination system of claim 1, wherein the light mixer has a basic shape which can be described by two right circular cones touching each other at their base surfaces.

13. The illumination system of claim 12, wherein the sub-elements have the shape of cone segments.

14. The illumination system of claim 1, wherein the light mixer at least essentially has the shape of a rhombus.

15. The illumination system of claim 1, wherein the at least one beam-splitter layer comprises at least two individual layers having different refractive indices.

16. The illumination system of claim 1, wherein the at least one beam-splitter layer is a polarization-selective beam-splitter layer.

17. The illumination system of claim 16, wherein the reflectivity for s-polarized light differs from the reflectivity for p-polarized light by a factor of 2.

18. The illumination system of claim 17, wherein the reflectivity for s-polarized light differs from the reflectivity for p-polarized light by a factor of 10.

19. The illumination system of claim 1, wherein the light mixer is arranged in a field plane of the illumination system.

20. The illumination system of claim 19, wherein the field plane passes through a symmetry plane of the light mixer.

21. An illumination system of a microlithographic projection exposure apparatus, having a light mixer for the homogenization of radiation distributions which comprises at least one row of beam splitters, wherein the beam splitters in at least one row are arranged
a) mutually parallel,
b) at an inclination angle with respect to an entry-side optical axis of the illumination system, and
c) offset behind one another in a direction perpendicular to the entry-side optical axis.

22. The illumination system of claim 21, wherein the inclination angle of the least one row is 45°.

23. The illumination system of claim 21, wherein the inclination angles respectively differ from one another in magnitude by 90° in rows which follow one another along the entry-side optical axis.

24. The illumination system of claim 21, wherein the beam splitters are arranged such that each light ray entering the light mixer strikes at least two beam splitters during its passage through the light mixer.

25. The illumination system of claim 21, wherein an optical element with a positive refracting power is arranged between each pair of neighboring beam splitters.

26. The illumination system of claim 21, comprising an entry-side imaging unit which splits an integral incident light beam into subsidiary light beams, which are directed at entry-side beam splitters.

27. The illumination system of claim 21, comprising an exit-side imaging unit which combines subsidiary light beams emerging from exit-side beam splitters to form an integral light beam.

28. The illumination system of claim 21, comprising a deviating device by which light passing through an outermost beam splitter of a row is directed onto a subsequent row.

29. The illumination system of claim 28, wherein the deviating device comprises at least one mirror.

30. The illumination system of claim 21, wherein the light mixer is arranged in a parallel beam path.

31. The illumination system of claim 30, wherein the light mixer is arranged in front of an optical element of the illumination system which is the first element that increases the divergence of the radiation distribution.

32. A projection exposure apparatus comprising an illumination system of claim 1.

33. A projection exposure apparatus comprising an illumination system of claim 21.
